(19) United States
(12) Patent Application Publication
(10) Pub. No.: US 2007/0033299 A1
(43) Pub. Date: Feb. 8, 2007

(54) Information processing device, and CPU, method of startup and program product of information processing device

(75) Inventor: Hiroki Arai, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/495,733

(22) Filed: Jul. 31, 2006

(30) Foreign Application Priority Data
Aug. 3, 2005 (JP) 2005-225897

(51) Int. Cl. G06F 3/00; G06F 13/00

(52) U.S. Cl. 710/10; 710/104

(57) ABSTRACT

In the information processing device of the invention, the region to be scanned is divided and assigned into as many parts as there are CPUs installed in the information processing device, each CPU scans hardware resources under its control respectively, and the main CPU integrates the scanning result at the end. According to the invention, the time necessary to scan the hardware resource can be reduced, and the startup time of the information processing device can also be reduced.

### BACKGROUND OF THE INVENTION

1. Field of the Invention

The invention relates to an art for high speed startup of an information processing device.

2. Description of the Related Art

Conventionally, an information processing device scans hardware resources at the time of startup in order to identify hardware configuration of the device. To the hardware resources detected in scanning, arbitrary hardware resource definition information should be assigned. Therefore, the hardware resources are scanned by one CPU. The time necessary for hardware resource scanning increases in proportion to the number of hardware resources installed in the device. Therefore, a large-scale information processing device having much hardware resources suffers from a problem of prolonged startup time.

Japanese Unexamined Patent Publication No. Hei 7(1995)-13928 discloses an art to dynamically change the terminal configuration in distributed processors by an instruction from a host computer. In this art, a maximum number of physical terminals which can be accommodated is defined as dummy information in terminal configuration information (static configuration information) fixedly loaded as a part of OS, and this static configuration information is mapped to terminal configuration information files received by download from a host computer after startup to define a terminal for operation in the distributed processors. When the terminal configuration information is altered or added, terminal configuration information file stored in a host computer is updated and downloaded to a distributed processor, then the distributed processor maps the altered terminal configuration information to the physical terminal configuration to dynamically change the terminal configuration during operation of the distributed processor.

However, an information processing device having a function to automatically detect hardware resources connected thereto scans hardware resource at the time of startup in order to identify its own device hardware configuration. To the hardware resources detected by scanning, hardware resource definition information (e.g., a device file in UNIX (trade mark) OS) should be assigned in order to discriminate it from other hardware resources.

In a conventional information processing device, because the hardware resource definition information is exclusively assigned to a hardware resource, the hardware resources are scanned by one CPU even if the processing device has plural CPUs.

Therefore, the hardware resource cannot be scanned efficiently, and in a large scale information processing device having a lot of hardware resources, startup takes a long time.

This is because when one CPU scans all hardware resources, the time necessary for scanning increases in proportion to the number of the hardware resources installed in the device.

### SUMMARY OF THE INVENTION

In order to solve above problem, the object of the invention is to reduce the time necessary for hardware resource scanning, thus to reduce startup time of an information processing device.

According to one aspect of the invention, an information processing device is provided wherein a region to be scanned is divided and assigned into as many parts as there are CPUs installed in the information processing device, each CPU scans the hardware resources under its control, and a main CPU integrates the scanning result.

According to another aspect of the invention, a CPU is provided wherein a region to be scanned is divided and assigned into as many parts as there are CPUs installed in an information processing device including the CPU itself, and the CPU and other CPUs scan the hardware resources under its control, and the CPU integrates the scanning result at the end.

According to yet another aspect of the invention, a method is provided wherein a region to be scanned is divided and assigned into as many parts as there are CPUs installed in an information processing device, each CPU scans the hardware resources under its control, and a main CPU integrates the scanning result.

According to yet another aspect of the invention, a program is provided which, when executed in a computer, makes the computer divide and assign a region to be scanned into as many parts as there are CPUs installed in the computer, makes each CPU scan hardware resources under its control, and makes the main CPU integrate the scanning result.

The invention has an advantage in that the time necessary for hardware resource scanning is reduced, thus, the startup time of the information processing device is reduced.

### BRIEF DESCRIPTION OF THE DRAWINGS

FIG. 1 is a block diagram which shows an information processing device according to an embodiment of the invention;

FIG. 2 is a drawing which shows an exemplary structure of the information processing device shown in FIG. 1;

FIG. 3 is a flow chart which shows operation of the hardware resources scan according to an embodiment of the invention; and

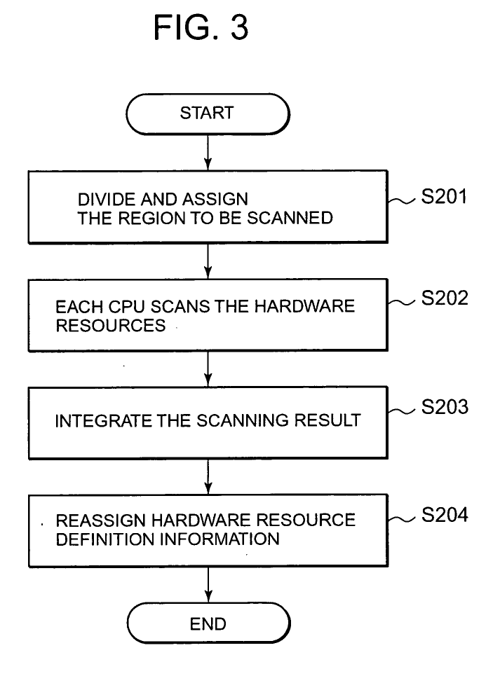

FIG. 4 is a drawing which shows examples of divided scanning tables and an integrated scanning table according to the invention.

### DETAILED DESCRIPTION OF THE PREFERRED EMBODIMENTS

Next, an embodiment of the invention will be described in detail with reference to the drawings.

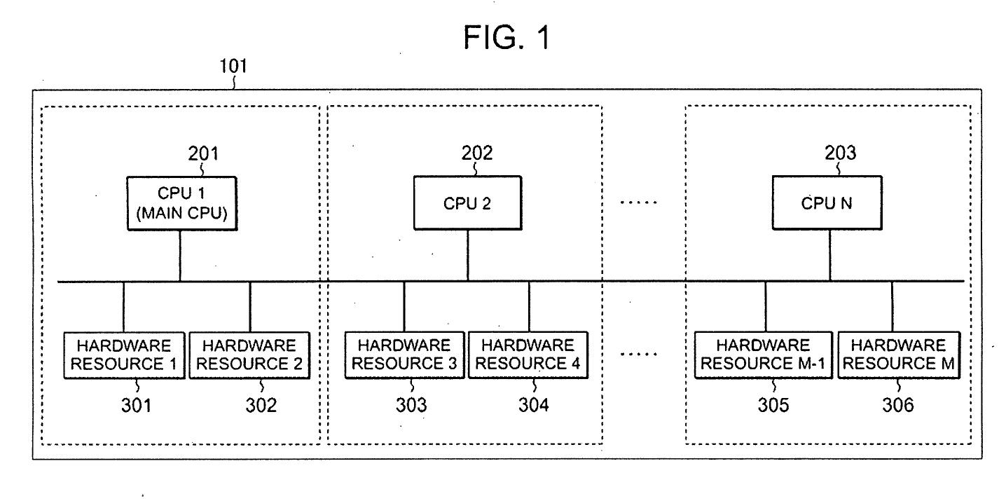

FIG. 1 shows information processing device 101 according to this embodiment including CPU1 201, CPU2 202, . . . , CPU N 203 (N is any positive integer) as CPUs, and resource1 301, resource2 302, resource3 303, resource4 304, . . . , resourceM−1 305, resourceM 306 (M is any positive integer) as hardware resources.

CPU1 201 is a main CPU, and has a function to divide the region to be scanned, a function to integrate the scanning result, and a function to reassign hardware resource definition information.

Example of information processing device 101 is a personal computer operating under control of a program. The device may have a known configuration including operation input unit, ROM (Read only memory), RAM (Random Access Memory), communication interface, HD (Hard Disk), CPU (Central Processing Unit), and these components may be connected via buses.

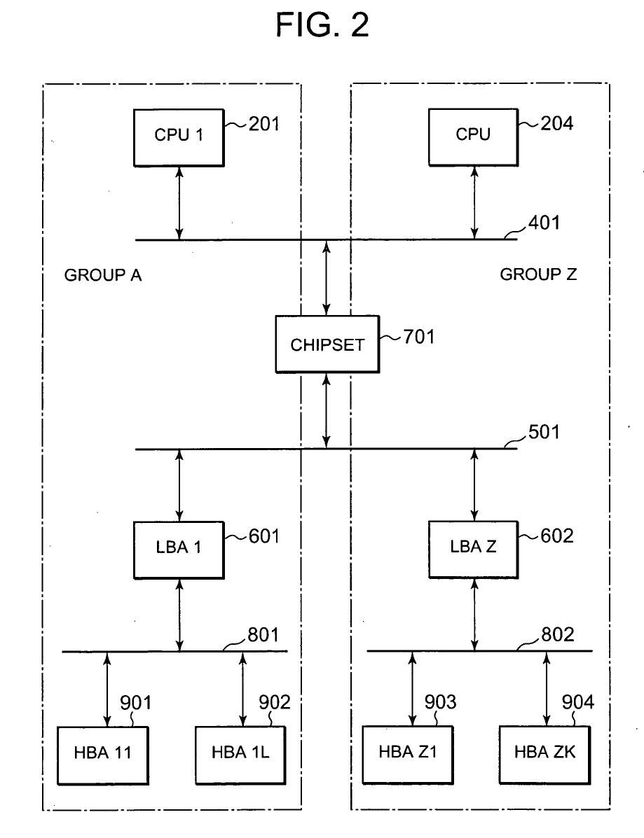

FIG. 2 is a drawing which shows an exemplary structure of the information processing device shown in FIG. 1. CPU1 201, CPU2 202, . . . , CPUZ 204 are connected to CPU bus 401. FIG. 2 shows an example in which the number N of CPU is larger than the number Z of LBA. CPUZ+1 to CPUN are connected to CPU bus 401, but not shown in FIG. 2.

CPU bus 401 and a local bus 501 which has LBA1 601, LBAZ 602 (Local Bus Adapter. Z is any positive integer) are connected via chip set 701. LBA and a host bus which has one or more HBA (Host Bus Adapter) are connected. LBA1 601 and host bus 801 which has HBA11 901, . . . , HBA1L 902 (L is any positive integer) are connected. LBAZ 602 and host bus 802 which has HBAZ1 903, . . . , HBAZK 904 (K is any positive integer) are connected.

Each CPU respectively stores a divided scanning table which designates the region to be scanned by the CPU in the RAM. In the divided scanning table, all HBAs and their corresponding IDs under LBA to be scanned by the CPU are stored.

Main CPU 201 stores an integrated scanning table in the RAM in addition to a divided scanning table designating the region to be scanned by main CPU 201. The integrated scanning table stores all HBAs and their corresponding IDs installed in information processing device 101.

Next, the operation flow of the hardware resource scanning according to the embodiment will be described with reference to FIG. 2.

First, the main CPU (CPU1 201) divides the region to be scanned by the number of CPUs installed in the information processing device (S201). Here, N CPUs are installed in the device. Particularly, the main CPU assigns Z LBAs detected in local bus scanning to one of N CPUs, and sends information on LBAs to be scanned by the CPU, to CPUL 201 to CPUZ 204.

For example as shown in FIG. 2, when the number N of CPUs is larger than the number Z of LBAs, Z CPUs are selected from N CPUs and for the selected CPUs, one LBA is assigned to one CPU. When Z is larger than N and smaller than N×2, one or two LBA is assigned to one CPU. That is, LBAs are assigned such that each CPU has almost equal number of LBAs to scan.

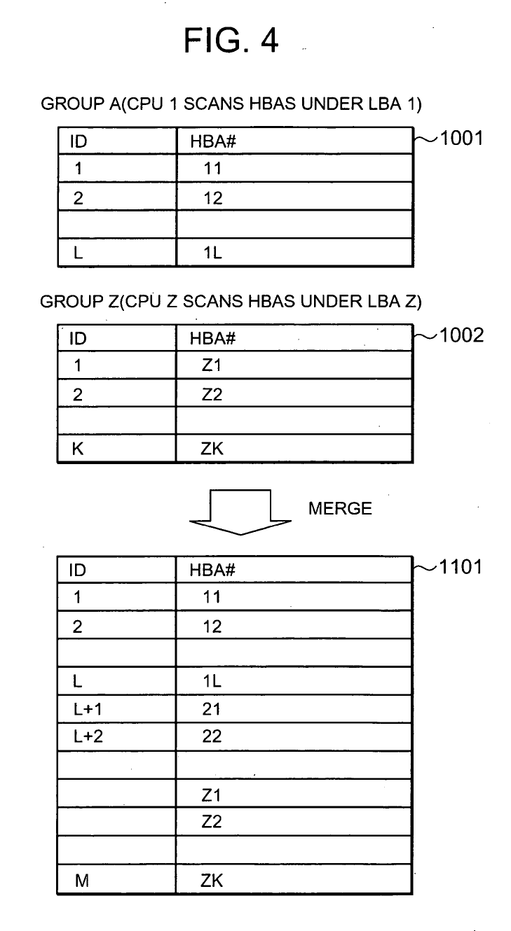

Each CPU (CPU1 201-CPUN 203) scans hardware resources under its control (resource1 301-resourceM 306, that is, HBA11 901-HBAZK 904), and assigns hardware resources definition information to each hardware resource (resource1 301-resourceM 306, that is, HBA11 901-HBAZK 904) (S202). Particularly, CPU scans HBAs under LBA to be scanned by the CPU according to the information received from main CPU. The CPU stores detected HBA and its corresponding ID in the divided scanning table. As shown in FIG. 4, when CPU1 detects L HAB11 to 1L under LBA 1 to be scanned by CPU1, CPU1 stores HBA and its corresponding ID in divided scanning table 1001. When CPUZ detects K HABZ1 to ZK under LBAZ to be scanned by CPUZ, CPUZ stores HBA and its corresponding ID in divided scanning table 1002. At the end of scanning, the divided scanning tables are sent to the main CPU.

And the main CPU (CPU1 201) integrates the scanning result (S203). The main CPU merges the divided scanning tables received from CPUs to generate integrated scanning table 1101.

Finally, the main CPU (CPU1 201) re-assigns the hardware resource definition information (S204). That is, the main CPU not only integrates the information of hardware resources under its control, but also carries out exclusive assignment of hardware resource definition information in order to explicitly discriminate the resource. As shown in FIG. 4, as temporary IDs assigned to LBAs may overlap, the main CPU re-assigns ID 1 to M to each HBA in order to avoid overlap between IDs of HBAs stored in integrated scanning table 1101.

Unlike conventional configuration in which only one CPU scans all the hardware resources, in the device according to the embodiment, plural CPUs scan hardware resources in parallel. Therefore, the time necessary for hardware resource scanning can be reduced, thus, the startup time of the information processing device can also be reduced.

Furthermore, the information processing device has a configuration in which plural CPUs have plural hardware resources under respective control. When a terminal group to be scanned by each distributed processor is predefined by physical connection, which CPU scans which hardware resource is unknown. Having the main processor assign hardware resources to each CPU makes high-speed startup possible.

The above embodiment is described only for illustrative purpose. Many alterations are possible without departing from the true spirit of the invention. For example, in order to achieve the function of information processing device in the above embodiment, a program describing steps of the function can be executed by the device. The program can be transmitted to other computer systems using a computer readable recording medium such as a CD-ROM or a magneto-optical disk, or on a carrier wave via transmission medium such as Internet or telephone lines.

What is claimed is:

1. An information processing device comprising:
a plurality of CPUs including a main CPU; and
hardware resources under control of said plurality of CPUs, wherein
the main CPU divides and assigns the region to be scanned into as many parts as there are CPUs installed in said information processing device, said plurality of CPUs scan hardware resources under its control respectively, and said main CPU integrates the result of the hardware resources scanning obtained from said plurality of CPUs.

2. The information processing device according to claim 1, wherein
said plurality of CPUs assign hardware resource definition information to every hardware resource under its control respectively at the time of scanning of said hardware resource, and said main CPU re-assigns said hardware resource definition information after integrating said scanning result.

3. A main CPU installed in an information processing device together with a plurality of other CPUs which scan hardware resources under its control respectively, wherein
the CPU divides and assigns the region to be scanned into as many parts as there are CPUs installed in said information processing device, the CPUs scan hardware resources under its control respectively, and the main CPU integrates the result of hardware resource scanning obtained from said plurality of other CPUs.

4. The main CPU of claim 3 wherein
after said integration of the scanning result, other CPU reassigns the hardware resource definition information assigned to each hardware resource.

5. A method to startup an information processing device having a plurality of CPUs including a main CPU, and hardware resources under control of said plurality of CPUs,
dividing and assigning the region to be scanned into as many parts as there are CPUs installed on said information processing device;
allowing said plurality of CPUs to scan the hardware resources under its control respectively; and
allowing the main CPU to integrate the scanning result obtained from the plurality of CPUs.

6. The startup method according to claim 5, further comprising:
allowing each CPU to assign hardware resource definition information to each hardware resource; and
allowing the main CPU to reassign the hardware resource definition information after integration of the scanning result.

7. A program product wherein
said program product, when executed in an information processing device, makes a main CPU of an information processing device divide and assign the region to be scan into as many parts as there are CPUs installed in the information processing device, makes each CPU of the information processing device scan hardware resources under its control respectively, and makes the main CPU integrate the scanning result.

8. The program product according to claim 7 wherein
said program product, when executed in a computer, makes each CPU of an information processing device assign hardware resource definition information to each hardware resource, makes the main CPU integrate said scanning result, and makes the main CPU reassign the hardware resource information.
